(19) United States
(12) Patent Application Publication
(10) Pub. No.: US 2014/0149163 A1
(43) Pub. Date: May 29, 2014

(54) INTERFACING A WEBLOG TO A CENTRALIZED ISSUE MANAGEMENT SYSTEM

(71) Applicant: CELLCO PARTNERSHIP D/B/A VERIZON WIRELESS, Basking Ridge, NJ (US)

(72) Inventors: David Raymond DEMPSKI, Washington, NJ (US); James Joseph SETTO, JR., Canonsburg, PA (US); Sandra Lee FLOWERS, Baden, PA (US); Cheryl Matthews RAKESTRAW, Niles, IL (US); Samir TAYEM, Mahwah, NJ (US); Fraser G. BOWIE, Bernardsville, NJ (US)

(73) Assignee: Cellco Partnership D/B/A Verizon Wireless, Basking Ridge, NJ (US)

(21) Appl. No.: 13/688,958

(22) Filed: Nov. 29, 2012

(51) Int. Cl. G06Q 10/06

(52) U.S. Cl. CPC G06Q 10/06311
USPC 705/7.15; 705/7.13

(57) ABSTRACT

A method that automatically links a Device Forum (DF) and a Quality Center (QC) is presented. In particular, data representative of a support issue provided through an interactive support channel of a mobile communications network provider is received at a DF server. A DF support case is established, via a DF web service running on the DF server, based on the support issue. A portal is displayed to facilitate management of a plurality of DF support cases including the DF support case. Upon determining that the DF support case has been viewed more than the threshold number of times, a message that instructs a Quality Center (QC) server to handle the support issue included in the DF support case is automatically transmitted to the QC server.

### BACKGROUND

An enterprise offering goods and/or services to consumers will often operate systems providing different channels and user interfaces, for enterprise interaction with consumers. The interactive channels may be for service to existing customers, etc. For example, an enterprise offering mobile communication devices and services to the public may operate systems and provide various interactive channels for customer services including, but not limited to, an online Web Channel for consumers; an in-store Retail Channel; a live operator Telesales Channel; a Handset Channel for access via mobile device; as well as others such as an automated Kiosk Channel, etc. The services offered by the interactive channels may include troubleshooting the customers' mobile devices.

The interactive channels may access an internal community forum (hereafter “Device Forums or (DF)”) to post a support issue that cannot be solved through the interactive communication with the customer. The DF may provide a place for the employees of the enterprise to post issues, share tips, post suggestions, and reply or comment on other posts. As such, the DF benefits the enterprise by bringing these device-related issues, suggestions, and tips to employees of the enterprise where all can review and share them. Such DF postings previously had to be manually imported into a Quality Center (QC), which is an issue management system that supports device vendors in resolving issues associated with their wireless devices and accessories. The enterprise may utilize the QC to capture device defects reported during the test and evaluation process and after commercial launch of the device. The manual transfer of the data from the DF to the QC is a time-demanding task, and currently there is no seamless interface between QC and the DF to automate post reporting, management and resolution.

To improve the efficiency of reviewing and resolving the support issues by the device vendors, a need exists to facilitate the capturing of support issues in the DF and automatically import the captured support issues into the QC.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates an exemplary enterprise environment offering a variety of communication services, including communications for resolving a support issue received through an interactive channel of the enterprise;

FIG. 2 illustrates an exemplary portal showing various DF support cases issued by various entities at the enterprise shown in FIG. 1;

FIG. 3 illustrates an exemplary user interface for creating a DF support case;

FIG. 4 illustrates an exemplary user interface showing various DF support cases associated with the Motorola Droid Razr 4G LTE device;

FIG. 5 illustrates an exemplary process for automatically creating a QC support case based on a DF support case at the QC web server shown in FIG. 1;

FIG. 6 illustrates an exemplary field-mapping table showing mapping between the DF support case fields and QC support case fields;

FIG. 7 illustrates an exemplary table showing mapping between various types of DF tag level 1 and QC issue classes;

FIG. 8 illustrates an exemplary table showing mapping between various QC issue states and DF statuses;

FIG. 9 illustrates an exemplary process for processing “Follow-up Requested” issue state at the QC;

FIGS. 10A and 10B illustrate an exemplary QC support case that may be forwarded to the vendor shown in FIG. 1;

FIGS. 11A and 11B illustrate an exemplary QC support case having an “Approved” status along with the vendor's response;

FIG. 12 illustrates a network or host computer platform, as may typically be used to implement a server; and

FIG. 13 depicts a computer with user interface elements, as may be used to implement a personal computer or other type of workstation or terminal device.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high level, without detail, in order to avoid unnecessarily obscuring aspects of the present teachings.

The drawings and discussions below relate to examples of techniques and equipment for providing an interface between the DF and QC to facilitate the capturing of support cases from the DF web log (blog) and automatically import the support cases into the QC in order to quickly and efficiently process the support cases. The interface may be bidirectional to support updates and follow-up requests from the QC. The interface may allow the device vendors to respond quickly to device issues and develop solutions to maintain customer satisfaction and reduce returns.

To illustrate one specific example, a DF web server of a mobile communication network provider receives, by way of a customer call center representative, data representative of a support issue and calls the DF web service running on the DF web server to handle the support issue. The DF web service establishes a DF support case based on the support issue. The DF web service is configured to display a portal to facilitate management of a plurality of support cases including the support case. The DF web service is further configured to forward the support case to the QC web server if the support case has been viewed more than a threshold number of times. For example, when the number of times the support case has been viewed is equal to 20, the DF web service creates an XML message and forwards the message to the QC web server. Other alternatives are contemplated. To this end, the threshold may have a temporal aspect associated with it. For example, the DF web service may be configured to forward the support case to the QC web server if the support case has been viewed more than a threshold number of times within a week or a month. The number of times the support case has been viewed may be reset after a certain time period (e.g., 26 weeks). The QC web server receives the XML message and calls QC web service running on the QC web server to handle the XML message. The QC XML web service uses an Open Test Architecture (OTA) Application Program Interface (API) to create a QC support case for the support issue. The QC support case is created based on a predetermined mapping between the QC fields in the QC support case and DF fields in the DF support case as described in more details below. The QC web service is configured to provide a portal to facilitate management of a plurality of QC support cases including the QC support case. In this manner, the enterprise automatically imports the support cases from DF into the QC, thereby allowing more efficient process for resolving the issues related to the imported support cases.

As used herein, a “support issue” may represent and/or include any complaint, inquiry, request, comment, critique, concern, controversy, matter, problem, or other issue provided by a customer through one or more of the interactive channels of the mobile communications network provider. For example, a support issue may include a communication (e.g., an email, a post, an instant message, etc.) including a complaint or inquiry associated with a perceived mobile device defect. In another example, the support issue may be related to one or more services associated with the mobile device. For example, the support issue may include a complaint or inquiry regarding a quality of services provided by the service provider of the mobile device.

A support issue may be the basis for a DF support case. As used herein, a “DF support case” may include a compilation of information (e.g., one or more electronic files storing information) related to a support issue upon which the support case is based and/or to a user who provides the support issue. For example, a support case may include DF blog post including information identifying the DF support case (e.g., a topic, tracking number), information regarding a type of DF support case, information regarding the entity responsible for creating the DF support case, information regarding number of replies associated with the DF support case, information regarding the number of viewers of the DF support case, information identifying the last post to the DF support case, information regarding a status of the DF support case, information regarding a priority of the DF support case, information regarding a source through which the support issue was provided, information regarding the content of the support issue, and/or any other information associated with the support issue and/or the user.

The DF support case may be the basis for a QC support case. As used herein, a “QC support case” may include information identifying the QC support case (e.g., a topic, tracking), information regarding manufacturer of a device associated with the QC support case, information regarding the model number of the device associated with the QC support case, summary information regarding the QC support case, information regarding classification of the QC support case, information regarding the number of occurrences associated with the QC support case and/or any other additional information recommended or necessary for device vendors to address the QC support case or provided by the device vendors in response to the QC support case. The additional information may include, for example, detail information regarding software version of the device, device ID, reporter identification, troubleshooting information, vendor responses, issue management information, ranking information, etc.

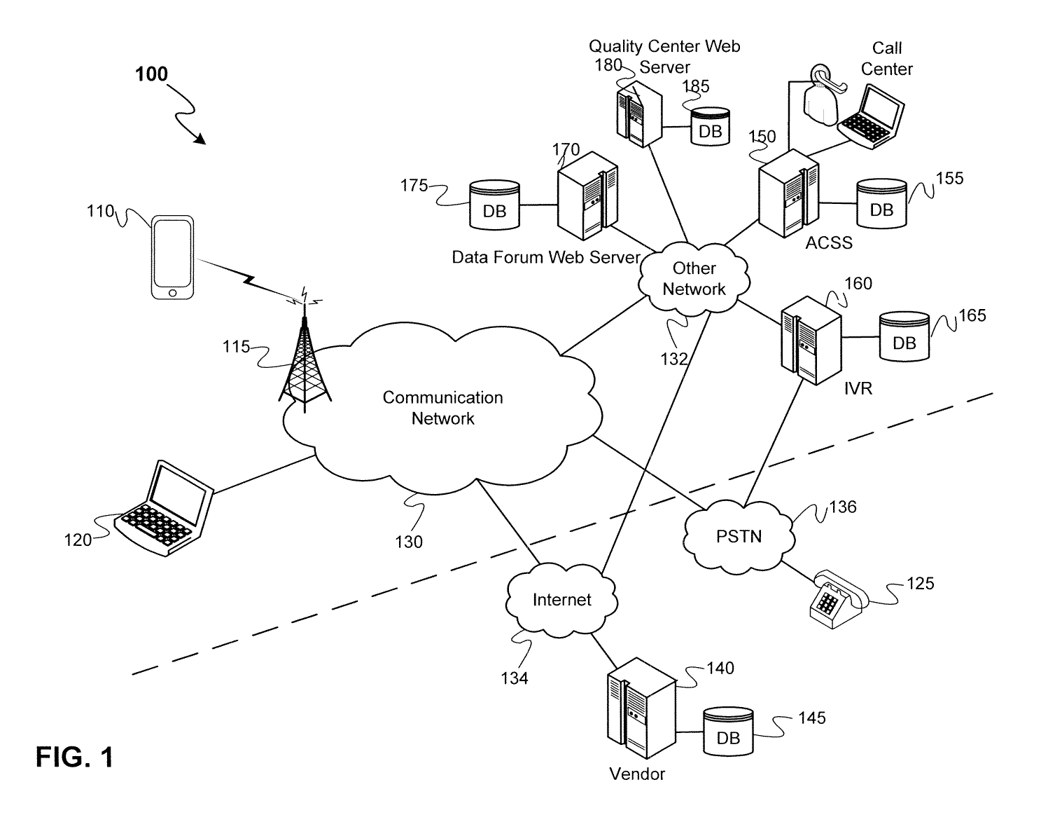

Reference now is made in detail to the examples illustrated in the accompanying drawings and discussed below. An exemplary enterprise network environment 100 is described initially with respect to FIG. 1. By way of illustration, the enterprise in our example operates a mobile communication network and offers its users and potential users (i.e., customers) communication services, as well as other services marketed and/or provided through the network. For example, the communication network 130 may be implemented as a network conforming to one or more well known wireless networking standards and protocols. Examples of such standards include, but are not limited to, the Code Division Multiple Access (CDMA) IS-95 standard, the 3rd Generation Partnership Project (3GPP) wireless IP network standard, the 3rd Generation Partnership Project 2 (3GPP2) wireless IP network standard, the Evolution Data Optimized (EVDO) standard, the Global System for Mobile (GSM) communication standard, the Time Division Multiple Access (TDMA) standard, or other standards used for public mobile wireless communications.

A framework for automatically interfacing the DF with the QC is associated with various interactive support channels of an enterprise. Examples of such interactive support channels include, but are not limited to, an online Web channel for retail consumers, an in-store retail channel, an interactive voice response (IVR) channel (e.g., as will be described in further detail below with respect to server 160 and database 165), a customer service channel including a call center, a live-person chat channel and telephone sales, a handset channel for access via a mobile device, and even automated channels such as an automated Kiosk channel and an automated chat channel (e.g., involving pre-defined answers to frequently asked questions, without any live-person interaction). Each of the different interactive support channels within the organization may be associated with a different system for providing self-service transactions to various users and managing user data. However, as will be described in further detail below, the interfacing DF to QC framework enables these systems to detect support issues and generate DF support cases using the DF web server 170. The DF support cases may automatically be imported to the QC web server 180 for handling. This may improve the customer experience for troubleshooting the customer's device, for example.

In the example illustrated in FIG. 1, the enterprise environment 100 includes a client device 110 and a client device 120, which communicate request messages to one or more servers 140, 150, 160 and 170 through a communications network 130, which can include, for example, one or more interconnected networks such as a network 132 and the Internet 134. Also, as shown in FIG. 1, servers 140, 150, 160, 170, and 180 are each communicatively coupled to a database 145, a database 155, a database 165, a database 175, and a database 185, respectively. In an example, servers 150 and 160, including their respective databases 155 and 165, are each associated with a different enterprise interactive support channel. The server 140 may be a vendor server in communication with QC web server 180 through network 132 and Internet 134. In one implementation, the vendor server 140 interacts with the QC web server 180 to resolve the support issues generated through one of the interactive support channels.

As will be described in further detail below, servers 150 and 160 may represent servers in an Automated Customer Support System (ACSS) arranged at a call center and an IVR system, respectively. Communication network 130 of enterprise environment 100 facilitates communications between various types of clients and at least one server for purposes of client access to the functionality of a service hosted at the server. Such functionality can be implemented in the form of a self-service transaction accessible to the client. Network 130 can thus be any network or combination of networks in an overall communication network for transmitting voice and types of data communications between various devices associated with the communication network. Network 130 can include, but is not limited to, a wired (e.g., Ethernet) or a wireless (e.g., Wi-Fi or 4G) network. In addition, network 130 can include a local area network, medium area network, and/or wide area network. Network 130 can support protocols and technology including, but not limited to, Internet or World Wide Web protocols and communication services. Intermediate network routers, gateways, or servers may be provided between components of enterprise environment 100 as may be necessary, depending upon a particular network implementation or computing environment.

In an example, communications network 130 allows users of client devices 110 and 120 (and other devices not shown) to initiate and receive telephone calls to each other, as well as through the public switched telephone network or “PSTN” 136 and a telephone station 125 connected to the PSTN. Additionally, network 130 enables users to request various data services via the Internet 134, such as downloads, web browsing, email, and other similar types of web services. Such data services are hosted on one or more application servers associated with network 130. As communications network 130 of enterprise environment 100 can be implemented using a number of interconnected networks, the overall network for the enterprise environment may include a number of radio access networks (RANs). Such radio access networks can also include a traffic network for transferring user communications and data; e.g., from client device 110 to base station 115 and other elements with or through which client device 110 communicates. The network can also include other elements that support functionality other than device-to-device media transfer services such as messaging service messages and voice communications. Specific elements of communications network 130 for carrying the voice and data traffic and for controlling various aspects of the calls or sessions are omitted here for simplicity.

The client devices 110 and 120 are examples of two types of client devices that may be used for communicating request messages to a web service hosted on one or more server(s) 140. In the example shown in FIG. 1, client device 110 is a mobile station or device for accessing mobile wireless communications services through communications network 130; for example, via one or more base stations (BSs) 115. Thus, client device 110 can be any type of mobile computing device capable of sending and receiving voice and data communications over one or more networks. Examples of such mobile computing devices include, but are not limited to, portable handsets, smartphones, tablet computers, and personal digital assistants. Similarly, client device 120 can be any type of general-purpose computing device, such as a desktop personal computer.

While the example in FIG. 1 shows only two client devices 110 and 120, enterprise environment 100 can be used to facilitate data communications for additional devices (not shown) over communications network 130. Similarly, enterprise environment 100 can include other servers, in addition to servers 150 and 160 for receiving support-related issues from the client devices 110 and 120. Furthermore, the present techniques may be implemented in communications network 130 using any of a variety of available communications networks and/or on any type of computing device compatible with such a network. As such, FIG. 1 is used herein to provide only a very simplified example of a few relevant elements of enterprise environment 100 and network 130, for purposes of discussion and ease of explanation.

In keeping with the previous example, a user of a mobile device (e.g., client device 110) may call the ACSS 150 to report a support issue relating to the user's mobile device. If the ACSS 150 cannot resolve the issue and/or the user requests to be transferred to the customer service representative, the call is forwarded to the Call Center. At the Call Center, the call is answered by the customer service representative. The customer service representative may address the user's issue over the phone. To do so, the customer service representative may access a DF web service operating on the DF web server 170 to identify whether other employees have dealt with similar issues and the manner in which they have resolved them. The other employees may include retail store employees and any other employee who uses the DF. The primary users, however, may be the call center users and the retail store employees. The DF web service is configured to display a portal to the customer service representative identifying the DF support cases stored in the database 175.

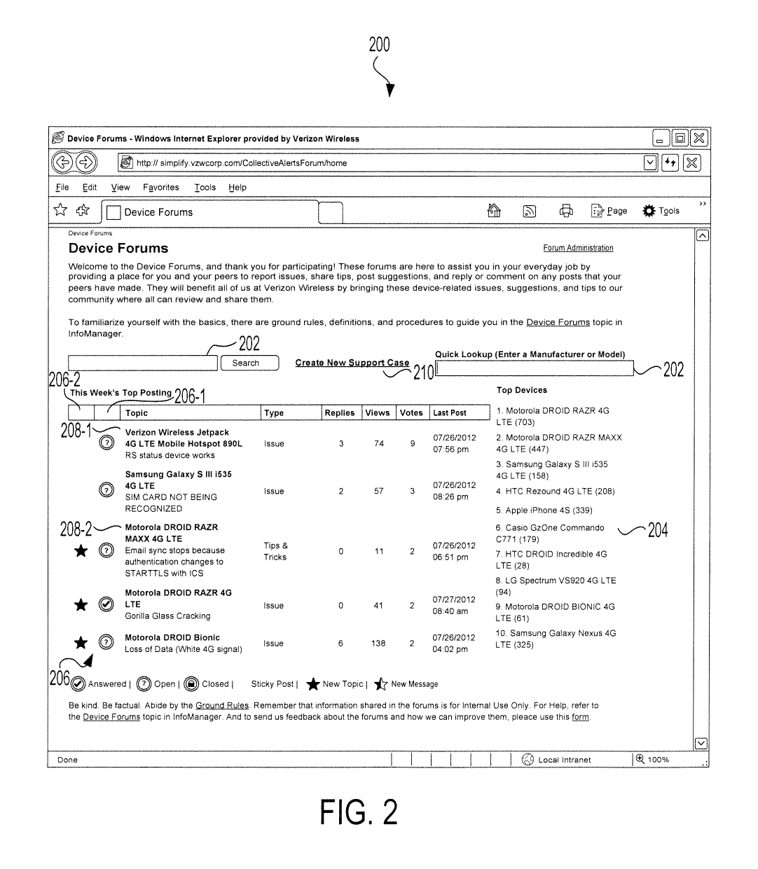

FIG. 2 illustrates an exemplary portal 200 showing various DF support cases issued by various entities at the enterprise 100. The portal 200 includes one or more search options 202 configured to facilitate the performance of one or more searches by way of portal 200. The search options 202 may include various search filters configured to find DF support cases including and/or representing one or more support issues. Any number of search options 202 may be included within portal 200 as may serve a particular implementation. The searches may be configured to run a single time or automatically at a selected frequency (e.g., hourly, daily, etc.).

Search results including a plurality of DF support cases may be displayed in list 204. The list 204 may include information associated with each DF support case such as, but not limited to, a topic associated with the DF support case, a type associated with the DF support case, replies associated with the DF support case, views associated with the DF support case, votes associates with the DF support case, last post associated with the DF support case, and device model information. The portal 200 may also include one or more identification options 206-1 and 206-2. The identification option 206-1 is configured to allow an operator to see if the DF support case is open, closed, or has been answered. The identification option 206-2 is configured to identify whether the DF support case is a new topic or an old topic. The status identification of the DF support case for being new or old may be determined from the date of its creation. A new topic may be one that has not been addressed in any way. An old topic may be one in an open status and still being investigated by the vendor, or one that has been addressed and is in an addressed or closed status.

In some examples, a DF support case included within list 204 may be selected by an operator to access additional information associated with that DF support case. To this end, one or more hyperlinks or the like may be included within list 204. For example, hyperlinks 208-1 and/or 208-2 may be selected to access additional information associated with DF support cases having a case description of “Verizon Wireless Jetpack 4G LTE Mobile Hotspot 890L” and “Motorola Droid Razr Maxx 4G LTE,” respectively. Each of the DF support cases listed in list 204 may be based on support issues received through one or more enterprise interactive support channels. In keeping with the previous example, FIG. 2 illustrates DF support cases based on support issues received by the customer service representative at the Call Center in FIG. 1.

The portal 200 may also display (e.g., in response to an operator selection of hyperlink 208-2) additional information associated with each DF support case. Additional information may include any suitable additional information associated with the DF support case. For example, additional information may include information regarding a status of the DF support case, information regarding disposition history of the DF support case, information regarding post date of the DF support case, information regarding manufacturer, model, device ID associated with the device experiencing the support issue, technical information associated with the DF support case (e.g., identification of the source of defects such as, for example, accessories, email, hardware, memory, messaging, power management, software, call quality, connectivity, contacts, 3rd party application), and/or information about the creator and location information of the DF support case.

Additionally or alternatively, to facilitate the creation of a DF support case based on the support issue, portal 200 may include a support case creation option 210. The support case creation option 210 allows the operator (e.g., the customer service representative) to create a DF support case of a given support issue the customer is experiencing, if one does not already exist in the DF database 175. To this end, the option 210 may include various options configured to allow the operator to establish a DF support case. For example, the operator may utilize the option 210 to input a case description, input keywords to be associated with the DF support case, select a case status for the DF support case, or provide any other information associated with the DF support case.

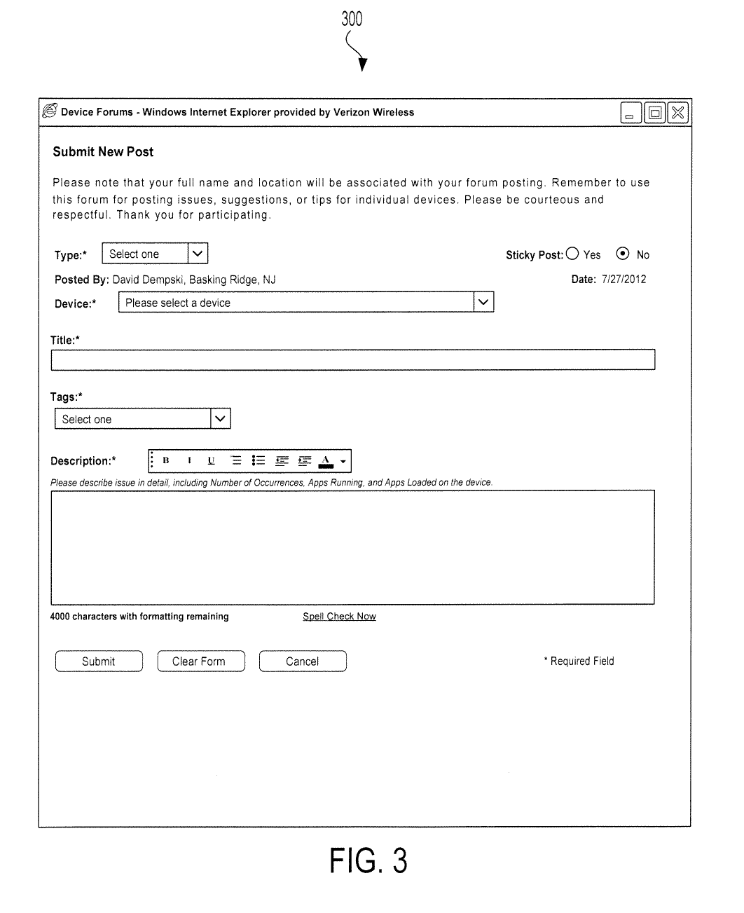

FIG. 3 illustrates an exemplary user interface 300 for creating a DF support case. The user interface 300 may be generated in response to the operator's selection of the option 210 in FIG. 2. As shown, the user interface 300 solicits information from the operator regarding the DF support case. The information includes the type of DF support case, information regarding the poster (e.g., creator) of the DF support case, information regarding the device experiencing the support issue for which the DF support case is being created, information regarding title, tag, and description of the DF support case. Once the information is provided by the operator, the operator may select the “Submit” icon to submit the DF support case to the DF web service. In response, the DF web service creates an entry for the DF support case in the list 204 and stores the DF support case in the database 175.

It will be recognized that a relatively large number of DF support cases (e.g., thousands) may be included in list 202. To assist an operator in accessing information associated with a particular DF support case, as noted above, various search options 202 may be displayed in portal 200.

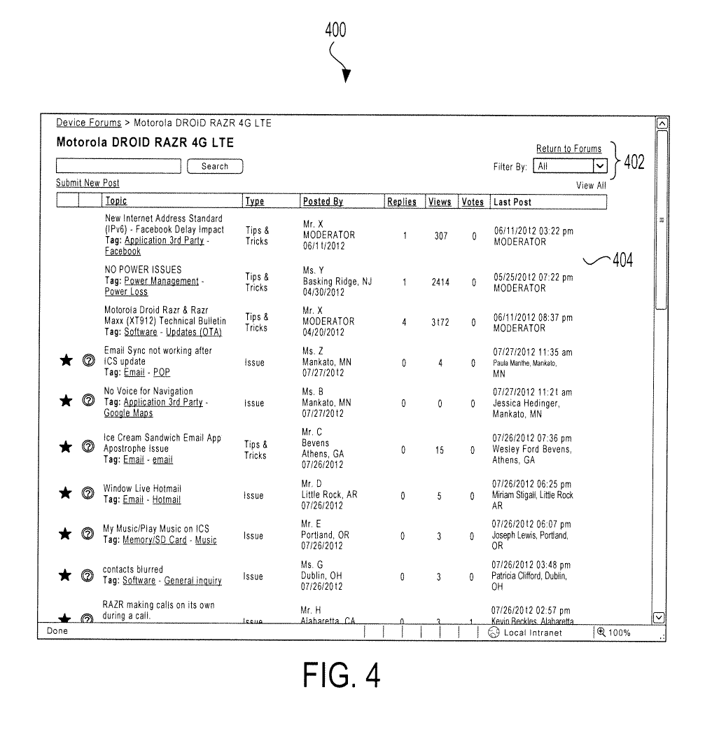

FIG. 4 illustrates an exemplary user interface 400 showing various DF support cases associated with the Motorola Droid Razr 4G LTE device. As shown in FIG. 4, search options 402 may include various search filters configured to narrow the number of entries in list 404 based on operator input. Any number of search options 402 may be included within portal 400 as may serve a particular implementation.

Referring again to FIG. 1, once the DF support case has been created and added to the list 204, the system 100 may automatically generate a QC support case based on the DF support case. In one specific example as described further below, once the number of views for the DF support case exceeds or equal a threshold, the DF web service may generate an XML message for forwarding the support case to the QC web server 180. The threshold may be set to 20, in one example. Upon receiving the XML message, the QC web server 180 calls the QC web service operating thereon to review the XML message and create a corresponding QC support case. The QC support case may be stored in the database 185. The QC support case may be ultimately reviewed by one of the vendors 140 and may be resolved by the reviewing vendor. Once the QC support case has been resolved, the message is communicated back to the DF web service, which will upload the responses to the corresponding DF support case and will flag the DF support case as being answered.

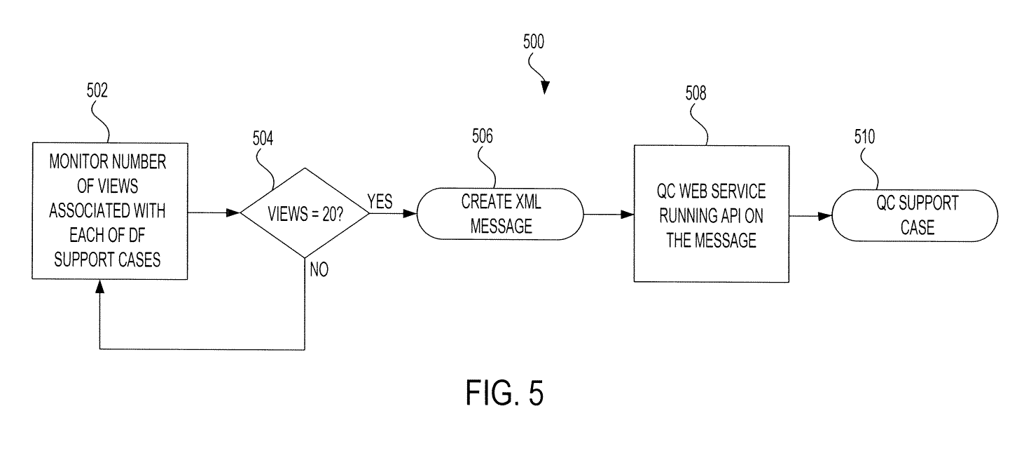

FIG. 5 illustrates an exemplary process 500 for automatically creating a QC support case at the QC web server 180 shown in FIG. 1. The process 500 begins with the DF web service monitoring the number of views associated with each of the DF support cases in the list 204 (Step 502). If the number of views associated with the DF support case does not exceed a specific threshold, the DF web service continues the monitoring step 502. If, however, the number of views associated with the DF support case exceeds the specific threshold (Step 504, Yes), the DF web service automatically creates a message including information regarding the DF support case and forwards the message to the QC web service. As shown in FIG. 5, the specific threshold includes 20 views in one example. This number may vary depending on the particular implementation. Alternatively or additionally, the threshold may be associated with another criterion such as, for example, a criticality of the DF support case. For example, if the DF support case has been marked as critical by the operator (e.g., the device marketing personnel), such as a security issue or related to a new product launch, the DF web service may forward it to the QC web service for creation of the QC support case. Thus, different thresholds may exist for different types of cases and different specific topics.

In one implementation, the interface between the DF web service and the QC web service includes an XML messaging service that automatically creates one or more XML messages (Step 506), as described below. Other types of messaging are contemplated, however. The XML message may include the description of the DF support case and any responses associated with the DF support case. The responses may be associated with the unique identifier of the support case. In one implementation, all of the responses to the support case may be included in the message. In another example, some of the responses to the support case may be included in the message. For example, the DF administrator may review the responses and decide which one to include in the message to the QC. This may apply for DF posts and replies that are manually transferred to the QC. In another example, all replies contributed to the DF post before 20 views are automatically included in the automated transfer to the QC. After the auto transfer at 20 views, the DF administrator may manually add additional DF replies to the QC, and in that case may decide which replies to transfer. The description may be previously provided by the operator at the time of the creation of the DF support case based on the DF support issue. The responses may be provided by the colleagues of the operator to help resolve the support issue. After being transmitted to the QC web service, the QC web service running on the QC web server 180 invokes the OTA API to convert the DF support case to the QC support case (Step 508) and outputs the QC support case 510.

The QC support case 510 may include a QC tracking number. The QC tracking number may be linked to the tracking number of the DF support case. The DF tracking number may be comprised of a unique DF support case number and the date of the post's creation. The QC may create its own separate tracking number when the DF support case is imported into the QC, while maintaining the DF support case tracking number. The API may execute daily (or other temporal) batches to retrieve additional posting information associated with the DF support case. The status of the DF support case may remain New or Open in the DF until it has been resolved at the QC. Alternatively, the status of the DF support case may change to Reported in the QC to reflect that the DF support case has been reported to the QC. In one implementation, the status of the DF support case may change automatically. In another implementation, the status of the DF support case may change manually. For example, upon generation of the XML message, the DF administrator may manually change the status of the DF support case.

Once the DF support case is reported to the QC, an operator of the QC may receive an email notification from QC informing the operator of the arrival of the support case. The e-mail may notify the operator of the QC that the XML message has been received and a corresponding QC support case has been created for the vendor's review. As noted above, the number of views (and/or views within a predetermined time period) of the DF support case may determine when a QC support case is created and if the severity needs to be escalated. For example, 20 views may result in a Severity B QC support case; whereas, 75 views may update the QC support case to Severity A. In addition to the severity field, the QC support case may include other fields. For example, the QC support case includes fields regarding DF class, disposition, and replies associated with the support case. If the DF/QC admin sees that many replies have been added to the DF support case before view numbers reaches 75, the DF/QC admin can manually change the severity level from A to B in the QC.

In one implementation, in addition to automatically creating QC support cases based on the number of views associated with the DF support cases, the system 100 also provides its operator with the ability to directly create QC support case. However, this ability may be limited to DF Moderators and Administrators. To automatically create the QC support case, the API accesses a field-mapping table. The field-mapping table pairs the DF support case fields to the QC support case fields.

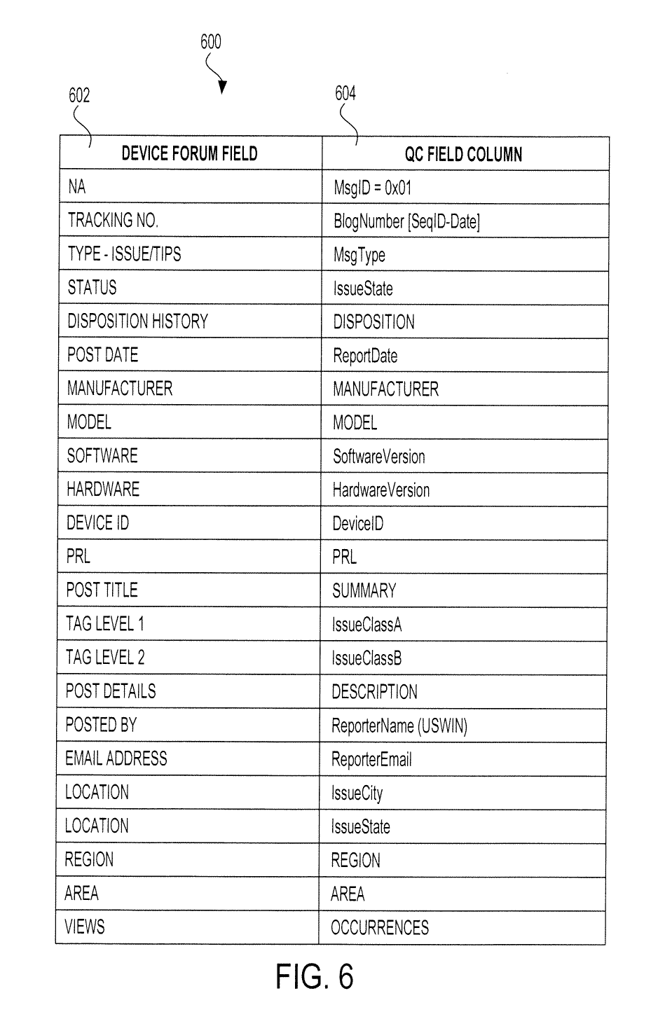

FIG. 6 illustrates an exemplary field-mapping table 600 showing one such mapping between the DF support case fields and QC support case fields. The table 600 includes DF field column 602 and QC field column 604. The DF field column 602 shows various fields associated with the DF support case. The QC field column 604 shows various fields associated with the QC support case. Each row in the table 600 shows the mapping between the field of the DF support case and the field of the QC support case. The QC support cases created via the interface may have existing QC default values (e.g., QC default severity may be a B). Some of the QC fields may not have default values associated with them. To this end, if there is no value specified for them in the XML message, they may be left empty or may be completed with a message indicating the value is to be determined. Each field may have a string type text or a memo type text. A field with a string type text may have a limited length; whereas, a field with a memo type text may have an unlimited length.

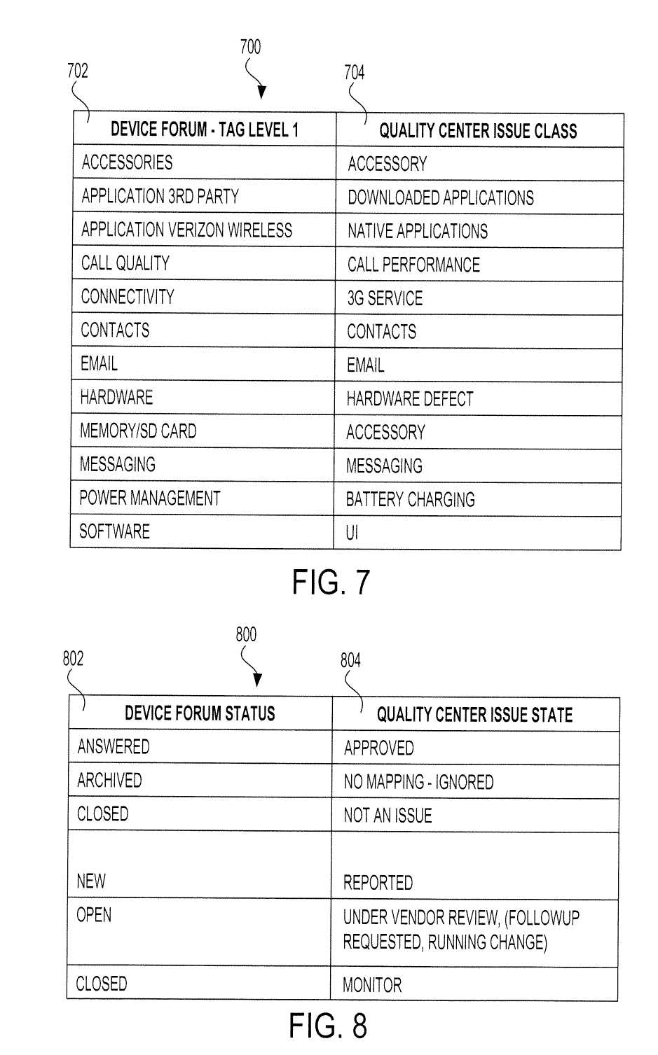

As shown, the various fields associated with the DF support case include a tracking number, a type (e.g., identifying whether the DF support case is associated with an open issue or whether the DF support case is associated with a tip in addressing a possible issue), a status (e.g., identifying whether the DF support case is open, closed, new, answered, etc.), disposition history and post date, a manufacturer, a model, software version, a device ID, and a Parameter Request List (PRL) associated with the mobile device experiencing the support issue, tag levels, identification of the creator of the support case and his/her contact information, and location information. The tag level identifies the source of the issue. For example, the tag level identifies whether the issue is associated with an accessory, third-party application, call quality, hardware, memory, etc. The various items falling under the tag level are shown in FIG. 7.

The various fields associated with the QC support case include a blog number, a message type (e.g., identifying the type of the DF support case: 1 for issues, 2 for tips, 3 for suggestions), an issue state (e.g., Reported), a disposition (e.g., identifying final disposition of the DF support case), a report date, a manufacturer, a model, software version, a device ID, and a PRL associated with the mobile device experiencing the support issue, a summary (e.g., post title associated with the DF support case), issue classes, a description, identification of the creator of the support case and his/her contact information, and location information.

FIG. 7 illustrates an exemplary table 700 showing the mapping between various types of DF tag level 1 and QC issue class. The mapping may be done by the DF/QC administrator based on frequency of subjects in the DF support cases. The table 700 includes a DF field tag column 702 and a QC field issue class column 704. The DF field tag column 702 identifies various tags that may be positioned in the “Tag Level 1” cell in column 602 of table 600. The QC field issue class column 704 identifies various issue classes that may be positioned in the “Issue Class A” cell in column 604 of table 600.

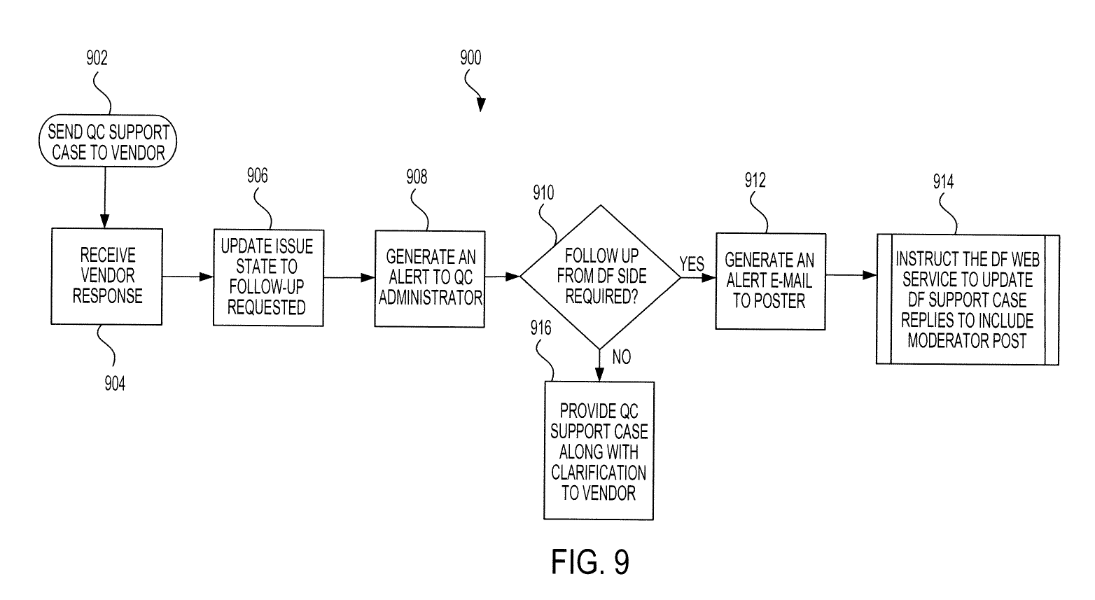

FIG. 8 illustrates an exemplary table 800 showing the mapping between various QC issue states and DF statuses. The mapping may be done by the DF/QC administrator based on frequency of subjects in the DF support cases. The table 800 includes a DF field status column 802 and a QC field issue state column 804. The DF field status column 802 identifies various statuses that may be positioned in the “Status” cell in column 602 of table 600. The QC field issue state column 804 identifies various issue states that may be positioned in the “Issue State” cell in column 604 of table 600. Once the support case is created, it may be assigned a “New” status in the DF. If this support case is viewed more than a threshold amount of times (e.g., 20) in the DF, the support case is reported to the QC. At the QC, a corresponding QC support case is created with an issue state being set to “Reported.” The issue state management may be done in QC by the Device Marketing Product Compliance team. The issue state of the QC support case may change over time depending on the interaction between the QC 180 and the vendor 140. For example, the issue state may change to one of “Approved,” “No mapping—ignored,” Not an issue,” “Under Vendor Review,” or “Monitor.” To illustrate, if the vendor 140 knows the answer to the issue, the vendor 140 provides the answer to the operator at the QC web server 180, which may approve the answer. The operator may update the QC support case to include the answer and also may update the state of the QC to “Approved.” In response, the QC web service sends a message containing the answer and the new issue status identifier “Approved” along with the relevant information identifying the corresponding the DF support case to the DF 170. The DF 170 invokes the DF web service, which updates the replies associated with the DF support case to include the answer to the issue and also updates the DF status to “Answered.” If the vendor 140 does not know the answer to the issue and requires further clarification, the vendor 140 may request a follow-up. The request is communicated to the QC 180, which will update the description and the issue state of the QC support case. The issue state may be set to “Under Vendor Review” or “Follow-up Requested.” In response, the QC web service generates a message for the DF 170. The message may include the follow-up question from the vendor and the new issue status identifier “Follow-up Requested” along with the relevant information identifying the corresponding DF support case. The DF web service may update the DF support case to include the question from the vendor and also may update the status of the DF support case to “Open.”

To this end, the DF interface may process the following issue states from QC: “Follow-up Requested,” “Pending Sample Return,” “Approved,” “Not an Issue,” and “Running Change.” In the follow-up process of the previous example, an operator in the QC changes the issue state to “Follow-up Requested.” The administrator at QC may review the vendor's questions and post them in the “Comments” field of the QC support case. The Issue State is then changed to “Follow-up Requested.” The QC web service sends a message to the DF informing of the status change and the vendor's question.

From DF side, an email alert may be sent to the DF poster and the follow-up questions added to the DF thread as a moderator post. The DF poster may provide feedback. For example, the notification email to the DF poster may contain an access URL. The email may only be sent to the individual that entered the DF support case (e.g., the post).

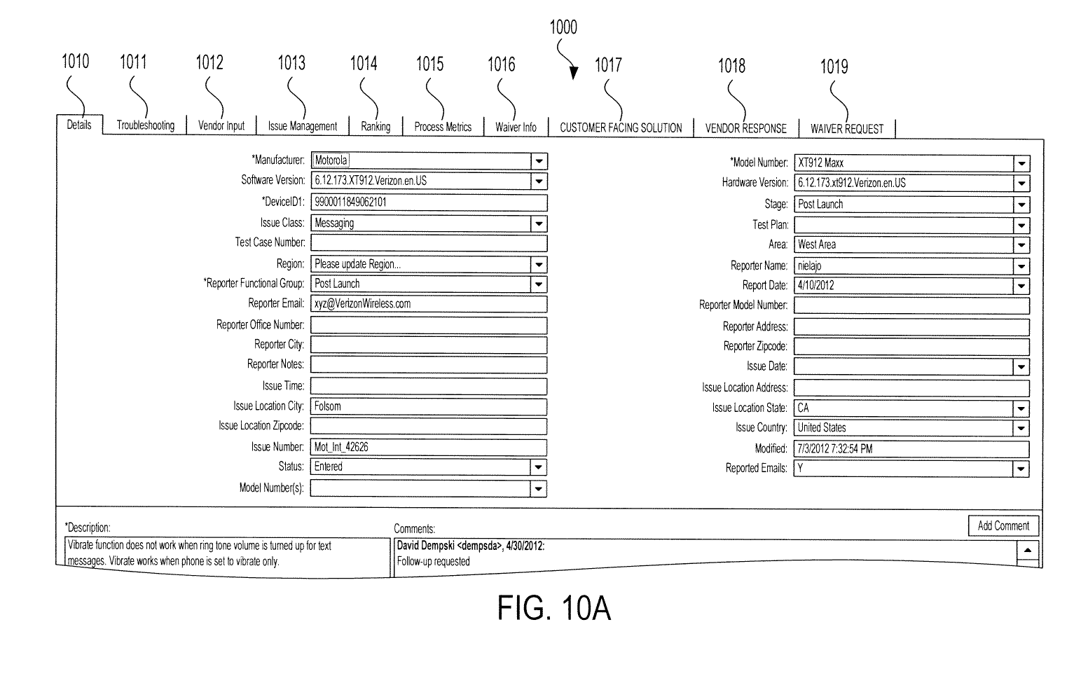

FIG. 9 illustrates an exemplary process 900 for processing “Follow-up Requested” issue state at the QC. The process 900 begins with the QC web service sending the QC support case to the vendor 140 for resolution of the support issue (Step 902). The QC support case at this stage may have “Vendor Notified” issue state and description associated with the QC support issue. The QC support case may also include information regarding other fields identified in column 604 of the table 600, such as, for example, a report date, a manufacturer, a model, software version, a device ID, and a PRL associated with the mobile device experiencing the support issue, a summary (e.g., post title associated with the DF support case), issue classes, a description, identification of the creator of the support case and his/her contact information, and location information.

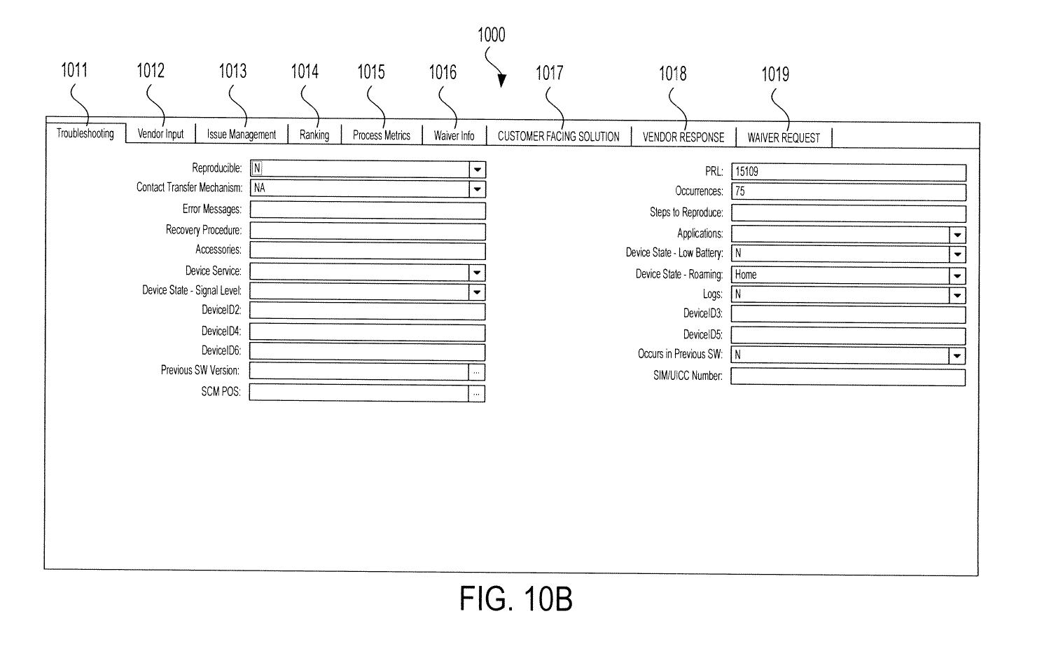

FIGS. 10A and 10B illustrate an exemplary QC support case 1000 that may be forwarded to the vendor 140. As shown, the QC support case 1000 includes a plurality of tabs 1010-1019. FIG. 10A shows the details of tab 1010 labeled “Details.” Tab 110 provides information regarding manufacturer of the mobile device, software version, device ID, reporter's email address, state identifier, etc. FIG. 10B shows the details of tab 1011 labeled “Troubleshooting.” Tab 1011 provides information regarding whether the issue is reproducible, the error messages, PRL, occurrences (e.g., the number of times this issue has been viewed in the DF), device state (e.g., home or roaming), battery state (e.g., low, medium, high), and whether or not issue occurred in the previous software version.

Moving forward and referring again to FIG. 9, the vendor 140 reviews the QC support case received from the QC web service and provides a response (Step 904). The response may be an answer addressing the issue or a request for additional information. In keeping with the previous example, it is assumed that the response is a request for additional information. The response may include the date of the response and the contact information of the operator creating the response along with information regarding the additional information. The response may also include a new state reflecting the vendor's request for additional information. In one implementation, the vendor 140 may review the QC support case and may provide its response within the QC support case. For example, the vendor 140 may includes its response under the vendor tab 1012. The vendor 140 may also access other tabs to provide additional information. For example, the vendor 140 may access the issue management tab 1013 to reflect a new state of “Follow-up Requested” (Step 906).

The QC web service receives the vendor's response and notices there is a follow-up request. In response, the QC web service generates an alert email to the QC administrator (Step 908). The email may indicate that the vendor 140 is seeking additional information on the reported QC support case having a blognumber, for example, Mot_int_{—}22028. The email may further direct the QC administrator to access the QC support case in the database 185 to answer the vendor's question in the response field.

The QC administrator reviews the question and determines whether the request for additional information requires information from the DF side (Step 910). If not (Step 910, No), the QC administrator returns the QC support case to the vendor along with the requested clarification (Step 916). If additional information should be obtained from the DF side (Step 910, Yes), the QC administrator using the QC web service generates a message to the DF 170. In one specific example, the QC administrator identifies within the proper field in the QC support case that additional information is necessary from the DF side. In response, the QC web service generates a status update message and a follow-up request message for seeking the additional information. The DF 170 may process the messages using the DF web service. The DF web service may generate an alert email to the poster of the DF support case that additional information is requested (Step 912). The email may be directed to the email address of the poster identified in the QC support case and may inform the poster that the administrator and/or vendor has reviewed and replied to the post. The email may further provide a link allowing the poster to view the reply.

The status update message may include an XML message and may be based on the information contained in the QC support case and the DF support case. The status update message may instruct the DF web service to update its status from “New” to “Open.” The follow-up request message may also include an XML message and may be based on the information contained in the QC support case and DF support case. The follow up message and the status update message may be combined into a single message. In one specific example, such message may have the following fields:

| Device Forum Field | QC-DF Message Field Name |
|---|---|
| NA | MsgID = 0x10 |
| TRACKING NO. | BlogNumber |
| ADMIN REPLIES | Comments |

The follow-up request message instructs the DF web service to update the DF support case replies to include comments from the vendor (Step 914). The poster of the DF support case may see the comment and may provide the follow-up response to the comment. For example, the poster may view the comment by accessing the link provided in the email to the poster. The selection of the link will take the poster to the comment and allow the poster to provide the follow-up response. The follow-up response may have the following fields:

| Device Forum Field | DF-QC Message Field Name |
|---|---|
| NA | MsgID = 0x03 |
| TRACKING NO. | BlogNumber |
| USER REPLIES | FollowupResponse |

If the responder is different than the poster of the DF support case, the ID of the poster and responder may be matched. In this manner, more than one poster may respond to a follow-up request. The follow-up response will be transferred to the QC support case Comments field and the device vendor 140 will be alerted that the updated QC support case should be viewed. Specifically, the follow-up response will be sent to the QC web service via an XML message from the DF web service. The QC web service will update the Comments field in the QC support case. Updating the comments field in the QC support case may result in a generation of an alert email to the QC administrator. The QC administrator may review the updated comments and decide whether the follow-up should be forwarded to the vendor for a response or whether it should be handled within the QC. The response may enable the vendor and/or the QC to adequately address the support issue. In either case, once the support issue has been adequately addressed, the operator of the QC may update the status of the QC support case to reflect the QC support case has been answered. In this case, the status of the QC support case may change to “Approved.”

When the QC status is set to one of the following: “Approved,” “Not an Issue,” “Running Change,” a QC administer update may be added to the corresponding DF support case. In the case of an “Approved” status, the latest entry in the QC Comments field may be posted with an indication that the DF support case has been addressed.

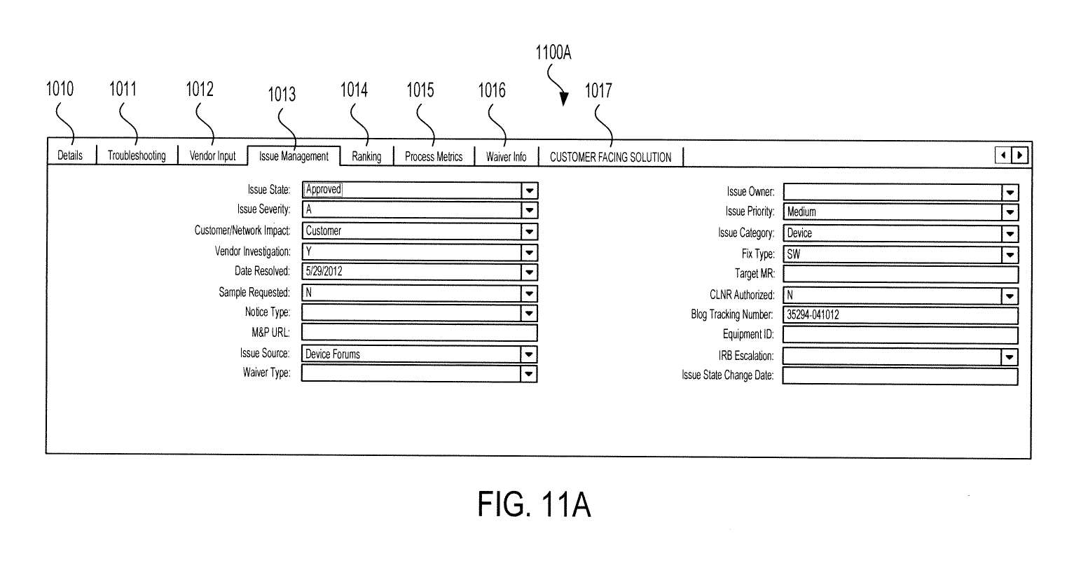

FIGS. 11A and 11B illustrate an exemplary QC support case 1100 having an “Approved” status along with the vendor's response. FIG. 11A shows the details of tab 1013 labeled “Issue Management.” Tab 1013 provides information regarding issue state, issue severity, customer/vendor impact, vendor investigation, date resolved, sample requested, issue source, etc. As shown, the issue state is set to “Approved,” reflecting that the issue has been answered and the answer has been approved by the QC administrator. Tab 1013 also shows that the vendor has investigated this issue. The vendor's response is shown in FIG. 11B, which shows the details of tab 1011 labeled “Vendor Response.” The tab 1011 provides information about the vendor's response. For example, as shown, the tab provides information regarding the responder's name and contact information and the detailed analysis for addressing the issue. The QC support case including the response is sent to the DF web service. In response, the DF web service may change its status from “Open” or “New” to “Answered” and resolution may be entered as an administrative reply.

In the case of “Not an Issue” status, the latest entry in the QC Comments field may be posted with an indication that the device with the alleged issue is working as designed and/or a behavior which has been approved by Device Marketing. In response, the DF may change its status to “Answered” and resolution may be entered as an administrative reply. In the case of “Running Change” status, the latest entry in the QC Comments field may be posted with an indication that this issue will be addressed in a post launch software update or upgrade. The DF may change DF support case status to “Answered” and resolution may be entered as an administrative reply.

As shown by the above process, functions relating to interfacing the DF with the QC may be implemented on computers connected for data communication via the components of a packet data network as shown in FIG. 1. Although special purpose devices may be used, such functions also may be implemented using one or more hardware platforms intended to represent a general class of data processing device commonly used to run “server” programming, so as to implement interfacing the DF with the QC functions discussed above, albeit with an appropriate network connection for data communication.

As known in the data processing and communications parts, a general-purpose computer typically comprises a central processor or other processing device, an internal communication bus, various types of memory or storage media (RAM, ROM, EEPROM, cache memory, disk drives, etc.) for code and data storage, and one or more network interface cards or ports for communication purposes. The software functionalities involve programming, including executable code as well as associated stored data; e.g., files used for interfacing the DF and QC. The software code is executable by the general-purpose computer that functions as the DF web service and/or that functions as the QC web service. In operation, the code is stored within the general-purpose computer platform. At other times, however, the software may be stored at other locations and/or transported for loading into the appropriate general-purpose computer system. Execution of such code by a processor of the computer platform enables the platform to implement the methodology for interfacing the DF with the QC in essentially the manner performed in the implementations discussed and illustrated herein.

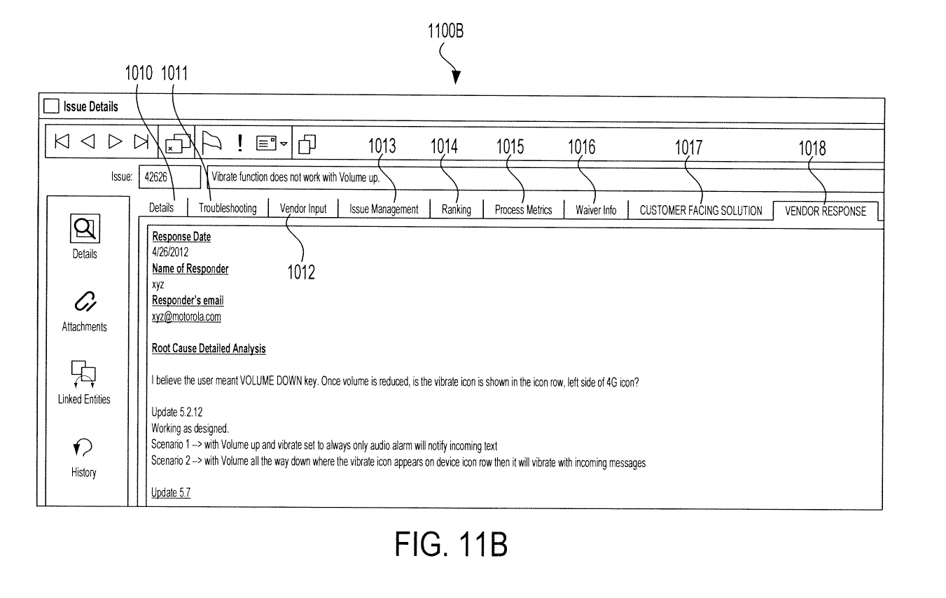

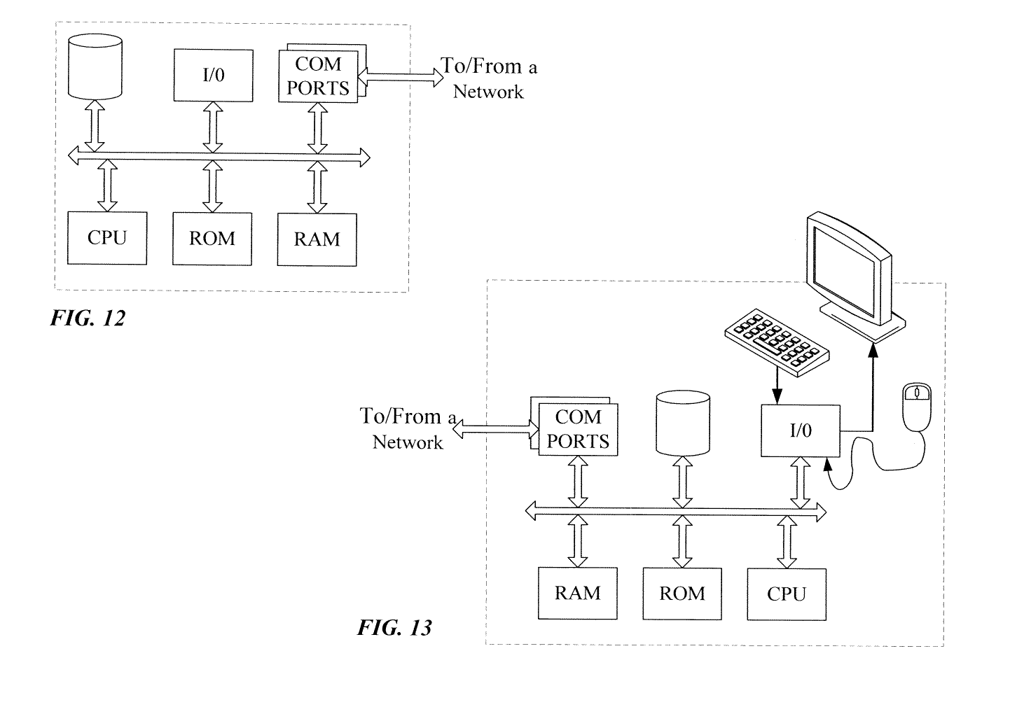

FIGS. 12 and 13 provide functional block diagrams of general purpose computer hardware platforms. FIG. 12 illustrates a network or host computer platform, as may typically be used to implement a server. FIG. 13 depicts a computer with user interface elements, as may be used to implement a personal computer or other type of work station or terminal device, although the computer of FIG. 13 may also act as a server if appropriately programmed. It is believed that those skilled in such implementations are familiar with the structure, programming and general operation of such computer equipment and as a result the drawings should be self-explanatory.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The server functions may be implemented in a distributed fashion on a number of similar platforms, to distribute the processing load.

A computer type user terminal device, such as a PC or tablet computer, similarly includes a data communications interface CPU, main memory and one or more mass storage devices for storing user data and the various executable programs. A mobile device type user terminal may include similar elements, but will typically use smaller components that also require less power, to facilitate implementation in a portable form factor. The various types of user terminal devices will also include various user input and output elements. A computer, for example, may include a keyboard and a cursor control/selection device such as a mouse, trackball, joystick or touchpad; and a display for visual outputs. A microphone and speaker enable audio input and output. Some smartphones include similar but smaller input and output elements. Tablets and other types of smartphones utilize touch sensitive display screens, instead of separate keyboard and cursor control elements. The hardware elements, operating systems and programming languages of such user terminal devices also are conventional in nature, and it is presumed that those versed in such technology are adequately familiar therewith.

Hence, aspects of the methods of interfacing DF with QC outlined above may be embodied in programming. Program aspects of the technology may be thought of as “products” or “articles of manufacture,” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, such as from a management server or host computer of the wide area network provider (e.g., LTE network provider) and/or the broadband provider into the computer platform of the DF server and/or the QC server. Thus, another type of media that may bear the software elements includes optical, electrical and electromagnetic waves, such as those used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible storage media, terms such as computer or machine-readable medium refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the functionalities relating to interfacing the DF and the QC as shown in the drawings. Volatile storage media includes dynamic memory, such as main memory of such a computer platform. Tangible transmission media includes coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include: a floppy disk, a flexible disk, hard disk, magnetic tape, any other magnetic medium; a CD-ROM, DVD or DVD-ROM, any other optical medium; punch cards, paper tape, any other physical storage medium with patterns of holes; RAM, PROM, EPROM, FLASH-EPROM, any other memory chip or cartridge; a carrier wave transporting data or instructions, cables or links transporting such a carrier wave; or any other medium from which a computer can read programming code and/or data. Many of these forms of computer-readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the systems to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
receiving, at a Data Forums (DF) server, data representative of a support issue provided by a user of mobile device through an interactive support channel of a mobile communications network provider;
establishing via a DF web service running on the DF server a DF support case based on the support issue;
displaying a portal to facilitate management of a plurality of DF support cases including the DF support case;
determining whether the DF support case has been viewed more than a threshold number of times; and
upon determining the DF support case has been viewed more than the threshold number of times, automatically transmitting a message to a Quality Center (QC) server that instructs the QC server to handle the support issue.

2. The method of claim 1, wherein the interactive support channel includes customer call centers and retail stores of the mobile communications network provider.

3. The method of claim 1, wherein the interactive support channel includes an on-line web channel of the mobile communications network provider.

4. The method of claim 1, wherein establishing the DF support case includes establishing a support case having a plurality of fields, the plurality of fields include a topic field, a type field, a replies field, and a views field.

5. The method of claim 1, wherein determining whether the DF support case has been viewed more than a threshold number of times includes determining whether the DF support case has been viewed more than the threshold number of times within a predetermined time period and the message is automatically transmitted to the QC server upon determining that the DF support case has been viewed more than the threshold number of times within the predetermined time period.

6. The method of claim 1, wherein the message includes an XML message, and the XML message includes description of the DF support case along with replies associated therewith.

7. The method of claim 1, wherein the portal includes a search filter configured to find DF support cases associated with one or more support issues.

8. The method of claim 1, wherein the portal includes an identification option configured to display a status of the DF support case, the status being: new, answered, open, or closed.

9. The method of claim 1, further comprising:
receiving at the DF web service and from the QC web service a message including an answer to the support issue;
automatically updating the DF support case to include the answer among replies associated with the DF support case; and
updating a status of the DF support case to answered.

10. The method of claim 9, further comprising:
receiving at the DF web service and from the QC web service a message including follow-up request regarding the support issue;
automatically sending a message to a poster of the DF support case requesting a response to the follow-up request;
receiving a response from the poster; and
forwarding the response as a part of an XML message to the QC web server.

11. A method comprising:
receiving, from a Device Forums (DF) web server and at a Quality Center (QC) web server, data representative of a support issue experienced by a user of a mobile device and received through an interactive support channel of a mobile communications network provider;
establishing via a QC web service running on the QC server a QC support case based on the support issue;
displaying via the QC web service a portal to facilitate management of a plurality of QC support cases including the QC support case; and
forwarding the QC support case to a vendor associated with the mobile device for addressing the support issue included in the QC support case.

12. The method of claim 11, wherein the interactive support channel includes customer call centers and retail stores of the mobile communications network provider.

13. The method of claim 11, wherein the interactive support channel includes an on-line web channel of the mobile communications network provider.

14. The method of claim 11, wherein receiving data representative of the support issue includes automatically receiving data representative of the support issue.

15. The method of claim 11, establishing the QC support case includes establishing a QC support case having a plurality of tabs; the plurality of tabs includes a vendor response tab, an issue management tab, and a troubleshooting tab.

16. The method of claim 11, further comprising:
receiving at the QC web server and from a vendor a message including an answer to the support issue;
automatically updating the QC support case to include the answer; and
sending a message to the DF web server including the answer.

17. The method of claim 16, wherein the message identifies a tracking number associated with the DF support case and a tracking number associated with the QC support case and further identifies the answer for including in the DF support case.

18. The method of claim 17, wherein the message includes an XML message.
